(19) United States
(12) Patent Application Publication
(10) Pub. No.: US 2006/0042893 A1
(43) Pub. Date: Mar. 2, 2006

(54) Mechanical lock-out device for front suspension system of bicycles

(76) Inventor: Jack Lin, Aliso Viejo, CA (US)

Correspondence Address: ROSENBERG, KLEIN & LEE, 3458 ELLICOTT CENTER DRIVE-SUITE 101, ELLICOTT CITY, MD, 21043, US

(21) Appl. No.: 10/924,791

(22) Filed: Aug. 25, 2004

(51) Int. Cl. F16F 9/12

(52) U.S. Cl. 188/266

(57) ABSTRACT

A suspension system for bicycles includes a cylinder received in the inner tube which is movably inserted in an outer tube. The outer tube is connected to the shaft of front wheel and the inner tube is connected to the crown of the front fork. A piston is connected to a switch by a rod and the switch can be rotated an angle by the user. The piston includes two protrusions which are rested on the top edges of the cylinder to lock the suspension or are rotated an angle to be movable in the cylinder.

### FIELD OF THE INVENTION

The present invention relates to a mechanical lock-out device to lock the front suspension system of bicycles when riding on roads.

### BACKGROUND OF THE INVENTION

Suspension systems have improved the performance and comfort of bicycles. Over rough terrain the suspension system can improve traction and handling by keeping the wheels on the ground, and a rider can easily maintain control at higher speeds and with less effort when the suspension absorbs some of the shock encountered when riding. However, when riding on roads with good condition, the higher rebound damping is a negative factor for controlling the bicycle and the cyclists have to overcome the friction caused by the rebound and therefore slowing the speed of the bicycles. A latest front suspension system for bicycles generally employs a hydraulic cylinder to absorb the shocks and a control valve is used to control the volume of the fluid in the cylinder so as to adjust the damping according to the conditions of the roads. Unfortunately, the suspension system includes complicated fluid paths in the control valve and the cylinder and a high cost is expected for these adjustable suspension systems.

The present invention intends to provide a front suspension system for bicycles wherein a simple mechanism lock-out device is used to switch the suspension system between the active status and lock-out status.

### SUMMARY OF THE INVENTION

The present invention relates to a suspension system for bicycles and comprises an outer tube having an open end through which an end of an inner tube is inserted. A switch is connected to the other end of the inner tube and is connected to a control rod and a piston having two protrusions is connected to the control rod. Two stop members are located in the inner tube and the piston can be stopped from moving by engaging the protrusions with the stop members, and moves toward the first end of the inner tube when the protrusions are rotated an angle to remove from the stop members.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show the suspension system of the present invention;

FIG. 2 shows the cylinder and the piston used in the suspension system of the present invention;

FIG. 3 is a cross sectional view to show that the inner tube is merged in the outer tube of the suspension system of the present invention;

FIG. 4 shows that the piston is rotated an angle and disengaged from the stop members of the cylinder;

FIG. 5 is a cross sectional view to show that the switch is rotated an angle to lock the suspension system of the present invention, and

FIG. 6 shows that the protrusions of the piston are rested on the stop members of the cylinder.

### DETAILED DESCRIPTION OF THE PREFERRED EMBODIMENT

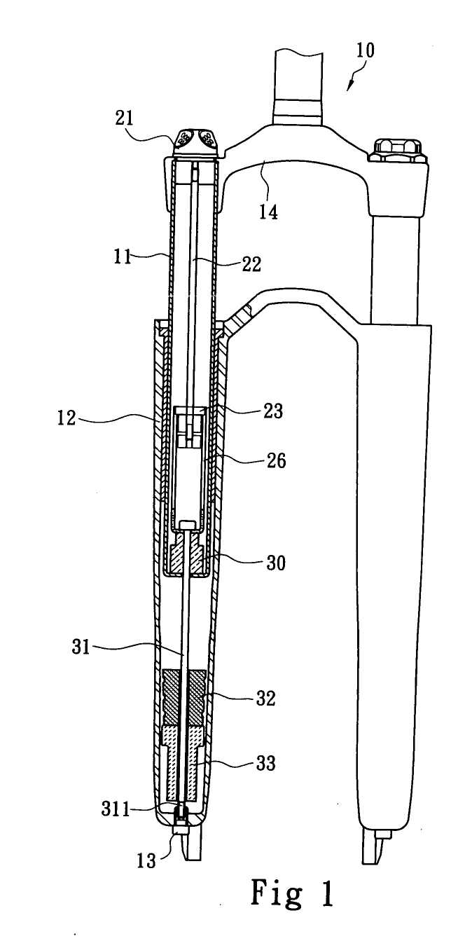

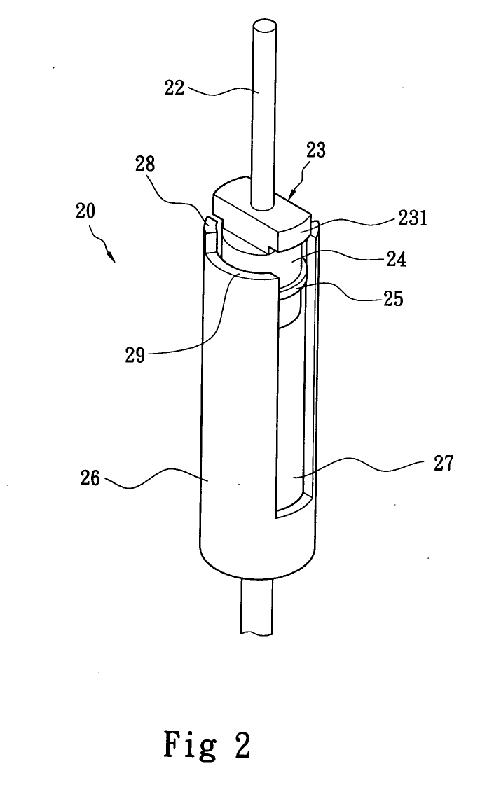

Referring to FIGS. 1 and 2, the suspension system 10 for bicycles of the present invention comprises two inner tubes 11 connected to two ends of the crown portion 14 of the front fork of a bicycle and the two inner tubes 11 are movably inserted in two outer tubes 12 from two respective open ends of the outer tubes 12. The two outer tubes 12 each have a close end which is connected to the front wheel shaft (not shown). The inner tube 11 has its first end movably inserted in the outer tube 12 via the open end of the outer tube 12 and the second end of the inner tube 11 connected with the crown portion 14 has a switch 21 rotatably connected thereto which is a part of the lock-out device 20 of the present invention. A control rod 22 has a first end fixed to the switch 21 and a second end of the control rod 22 is connected to a piston 24 which has an elongate board on a top thereof. The elongate board includes two protrusions 231 on two ends thereof. The cylinder 26 includes an open end through which the piston 24 is inserted and two slots 27 are defined in a wall of the cylinder 26 and communicate with the open end. The two slots 27 are sized such that the protrusions 231 are allowed to be movable therein. The two slots 27 separate the wall of the cylinder 26 into two parts and each part has a top edge which performs a stop member 29 for stopping movement of the piston 24. The two protrusions 231 are removably rested on the top edges respectively when the suspension system 10 is in its locked status. Each of the two top edges of the cylinder 26 has a limitation member 28 extending therefrom so as to limit rotation of the two protrusions 231. A piston ring 25 is mounted on the piston 24 and snugly engaged with an inner periphery of the cylinder 26.

A first damping block 30 is located between a lower end of the cylinder 26 and an inside of the first end of the inner tube 11. Two second damping blocks 32, 33 are received in the outer tube 12 and a connection rod 31 extends through the close end of the outer tube 12, the second damping blocks 32, 33, the first end of the inner tube 11, the first damping block 30 and a close end of the cylinder 26. A nut 18 is threadedly connected to the threaded section 311 of the connection rod 31 at the close end of the outer tube 12. The connection rod 31 can be movable through the close end of the cylinder 26.

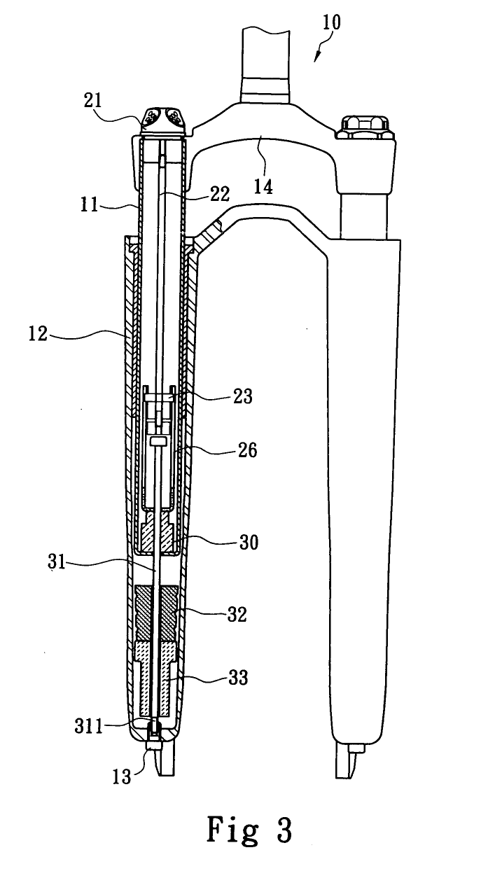

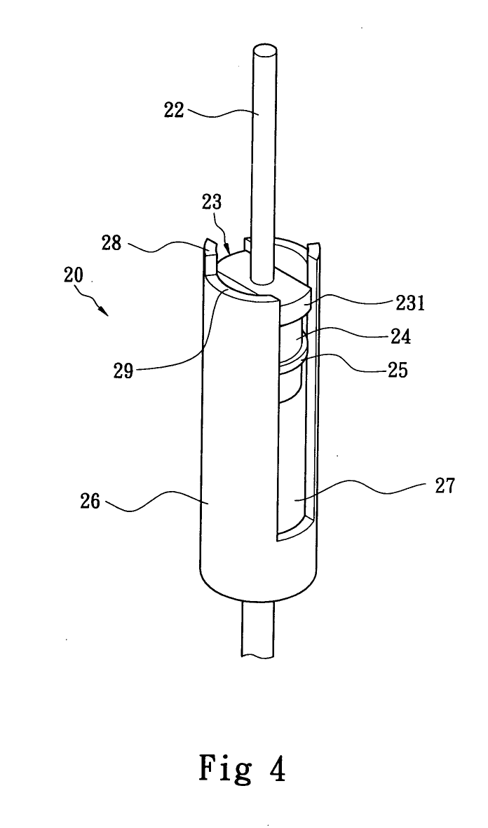

As shown in FIGS. 3 and 4, when the lock-out device 20 is not activated, the switch 21 is located at a position where the two protrusions 231 are located in the slots 27 such that when the bicycle goes over a bump, the inner tube 11 is lowered and the piston 24 moves into the cylinder 26 to absorb the load and shocks.

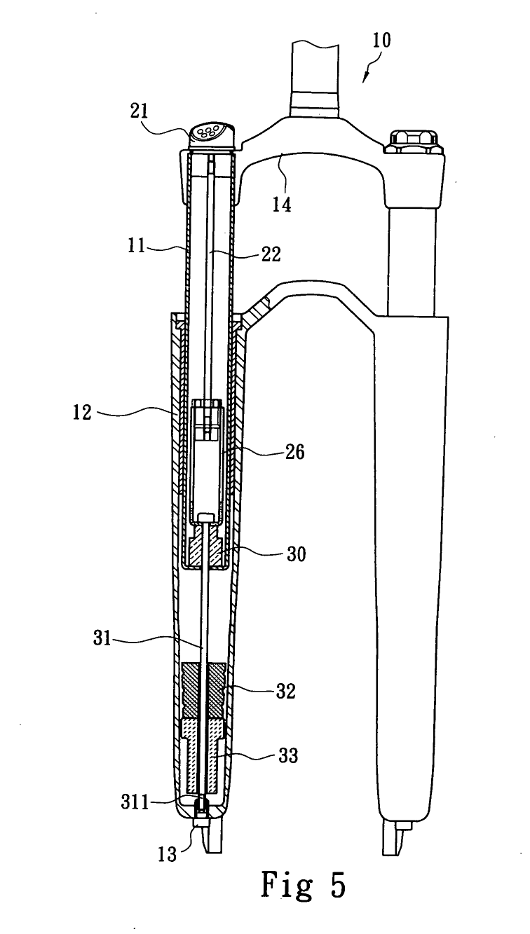

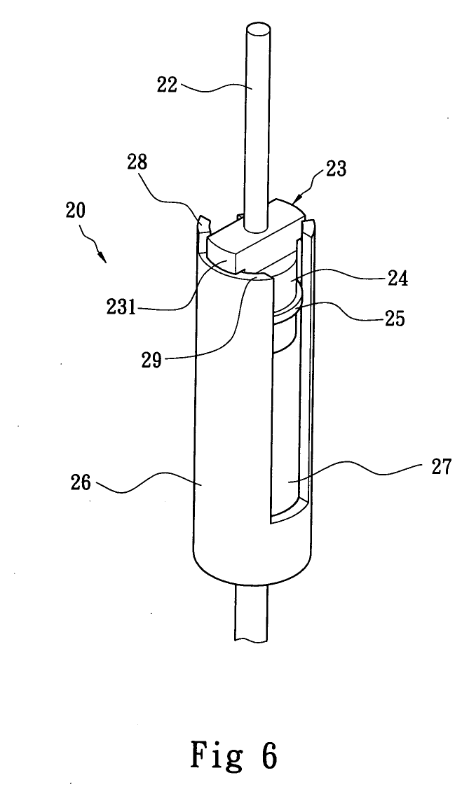

As shown in FIGS. 5 and 6, when the switch 21 is rotated 90 degrees to let the two protrusions 231 be rested on the stop members 29 of the cylinder 26, the piston 24 cannot be lowered into the cylinder 26. In other words, the suspension feature is locked and no relative movement between the inner tube 11 and the outer tube 12. The limitation members 28 limit rotation of the two protrusions 231 so that the user is altered that the lock-out positions of the switch is set.

The mechanical lock-out device 20 includes less number of parts and needs no extra tools to operate it. The first damping block 30 provide a minimum cushion feature when the lock-out device is set to lock the suspension system.

While we have shown and described the embodiment in accordance with the present invention, it should be clear to those skilled in the art that further embodiments may be made without departing from the scope of the present invention.

What is claimed is:

1. A suspension system comprising:
an outer tube having an open end and a close end;
an inner tube having a first end movably inserted in the outer tube via the open end of the outer tube and a second end of the inner tube having a switch rotatably connected thereto, a control rod having a first end fixed to the switch and a second end of the control rod connected to a piston which has two protrusions;
two stop members located in the inner tube and the piston being stopped from moving by engaging the protrusions with the stop members and moving toward the first end of the inner tube when the protrusions are rotated an angle to remove from the stop members.

2. The suspension system as claimed in claim 1, wherein a cylinder is received in the inner tube and includes an open end through which the piston is inserted, two slots defined in a wall of the cylinder and communicating with the open end, the two slots being sized such that the protrusions are movable in the slots.

3. The suspension system as claimed in claim 2, wherein the stop members are two respective top edges of two parts separated by the two slots of the wall of the cylinder and the two protrusions are removably rested on the top edges respectively.

4. The suspension system as claimed in claim 3, wherein each of the two top edges of the cylinder has a limitation member extending therefrom so as to limit rotation of the two protrusions.

5. The suspension system as claimed in claim 2 further comprising a piston ring mounted on the piston and snugly engaged with an inner periphery of the cylinder.

6. The suspension system as claimed in claim 2 further comprising a first damping block located between a lower end of the cylinder and an inside of the first end of the inner tube.

7. The suspension system as claimed in claim 6 further comprising a second damping block received in the outer tube and a connection rod extends through the close end of the outer tube, the second damping block, the first end of the inner tube, the first damping block and a close end of the cylinder.
